(19) United States
(12) Patent Application Publication
(10) Pub. No.: US 2002/0169517 A1
(43) Pub. Date: Nov. 14, 2002

(54) Quality monitoring procedure

(76) Inventor: Joerg Hudelmaier, Ulm (DE)

Correspondence Address: CHRISTIE, PARKER & HALE, LLP, 350 WEST COLORADO BOULEVARD, SUITE 500, PASADENA, CA, 91105, US

(21) Appl. No.: 09/852,142

(22) Filed: May 9, 2001

(51) Int. Cl. G06F 7/00

(52) U.S. Cl. 700/213

(57) ABSTRACT

The invention relates to a quality monitoring procedure for executing and monitoring the manufacturing process of a mixed material produced from a number of initial materials, in particular ready mixed concrete and similar constructional materials, with the following steps:

provision of at least a substantial part of the initial materials in a certain quality level;

transfer of at least a substantial part of the initial materials to a remotely situated processing site;

execution of a program controlled manufacturing process for the mixed material from the initial materials using a mobile manufacturing device which can be set up at the processing site;

interchange of remotely transmitted command and/or monitoring signals between any control station remotely situated from the mobile manufacturing device and the mobile manufacturing device for at least starting the program controlled manufacturing process for manufacture of the mixed material from the initial materials. The invention also relates to a quality monitoring system and a mobile manufacturing device.

The present invention relates to a quality monitoring procedure for executing and monitoring the manufacturing process of a mixed material that can be produced from a number of initial materials, in particular ready mixed concrete and similar constructional materials. Furthermore, a quality monitoring system according to claim 11 and a mobile manufacturing device, in particular a truck mixer, according to claim 21 are claimed.

In particular, during the manufacture of mixed materials, such as for example concrete, and apart from the quality of the initial materials, the manufacturing method plays a decisive role in the quality of the end product to be processed or the processed end product. Based on the currently usual procedure for ready mixed concrete, the fundamental problems are explained in the following using examples.

In a concrete plant the effort arising in the manufacture of a high-quality product is enormous. At the time point at which the concrete is filled into a truck mixer at the concrete plant the product is no longer subject to the strict requirements prevailing in the concrete plant. This means that once the truck mixer has left the concrete plant, the product inspection is completely in the hands of the vehicle driver and the persons carrying out the processing at the processing site. Already during the trip the hydration process that soon occurs, a chemical reaction between water and cement, influences the concrete quality. In particular temperature and time parameters, which have an effect during the transport and during the processing of the concrete, influence the actual quality—significantly depending on circumstances.

In addition, there may be uncontrollable manipulation at the construction site, perhaps due to the addition of impermissible and furthermore usually uncontrolled amounts of water. Drivers of concrete transport vehicles and operators of concrete pumps exhibit in part an inadequate or a complete lack of training in concrete technology. This is all the more surprising because these persons are generally responsible for the quality as delivered at the construction site and for the proper processing of the end product.

There is a further problem with the currently usual practice in that errors in applying the concrete at the construction site (e.g. poor compaction) remain undetected before the concrete hardens. Even if samples are taken at the construction site, this is likely to lead to unsatisfactory results in practice, because defective quality can only be established after days or weeks. This is principally due to the fact that the inspection procedures currently available can only be carried out on the hardened concrete.

It can be seen from the above explanation that the enormous effort taken in the concrete mixing plants is often significantly degraded by improper and unqualified access and intervention. The losses arising due to this type of improper delivery and application of concrete are substantial, in particular due to the rectification measures which must be applied very soon afterwards.

Therefore, it is the object of this invention to provide a quality monitoring procedure which enables the provision of high-quality concrete in a simple manner.

According to the invention, this object is solved by a method comprising the following steps:

Provision of at least one substantial part of the initial materials in a certain quality level;

Transfer of the substantial part of the initial materials to a remote processing site;

Executing a program controlled manufacturing process for the mixed material from the initial materials using a mobile manufacturing device which can be set up at the processing site;

Interchange of remotely transmitted commands and/or monitoring signals between a control station situated remotely from the manufacturing device and the mobile manufacturing device for at least starting the program controlled manufacturing process for the mixed material from the initial materials.

With this method the complete manufacturing process for the mixed material through to delivery at the processing site is controlled from a universal control station. With respect to concrete technology this means for example that a control station can be present, preferentially in a cement plant or in a loading station for an initial material, which, once the quality of the initial materials has been inspected, also monitors further processes. The concrete (mixed material) is at this point in time not yet manufactured by mixing the individual initial materials, but instead the manufacture occurs only at a later point in time using the mobile manufacturing device on site. This can be, for example, a specially designed truck concrete mixer which only mixes the initial materials together after receiving a certain remotely transmitted control signal. This also means that the actual manufacturing process for the concrete no longer takes place in the concrete mixing plant, but instead at the processing site or, if necessary, in a certain timeframe before arriving at the processing site in the mobile manufacturing device. This manufacturing process then runs under program control, so that the manufacture of the mixed material occurs with exactly defined process parameters. The individual quantities of the initial materials can be precisely specified as at the concrete mixing plant. The start signal and any monitoring signals are passed to the mobile manufacturing device from the control station so that the initiation of the manufacturing process occurs from the control station. The driver of the mobile manufacturing device, which is preferentially self-propelled and equipped as a vehicle, should where possible have no access to this process. Since the manufacture of the mixed material always occurs “fresh”, no hydration process sets in, as in the case of concrete. Consequently, addition of extra water is not required or is carried out specifically and controlled within the framework of the recipe. Appropriate monitoring and correction signals, which can be interchanged between the mobile transport unit and control station, then ensure extensive continuous monitoring of the manufacturing process for the mixed material. With this procedure it is ensured that a mixed material with a completely defined quality can be delivered at the processing site. In particular with mixed materials, which are subject to a further chemical reaction due to the bringing together of all initial materials, it is particularly advantageous if the mixed material can be processed immediately after its manufacture. The control station ensures that during the concrete process the quality standard can be maintained at an adequate level. The monitoring can be designed such that access and intervention in the process sequence are immediately detected or can be completely eliminated.

Furthermore, the transfer of at least the substantial part of the initial materials can take place using at least one mobile transport unit. In particular with the preparation of large quantities of mixed material at the processing site a number of transport units can ensure an adequate supply of high-quality initial materials at the mobile manufacturing device. This can then produce mixed material almost uninterrupted. Since the manufacturing device is designed to be mobile, this manufacturing site can be selected as required. In connection with this it is also possible to use temporary storage of the initial materials and to fill the temporary stores with an adequate quantity from the mobile transport units. This has the advantage, particularly in concrete technology, that this type of mobile transport unit may be a simple tipper truck which is substantially less expensive than a truck concrete mixer.

The mobile transport unit can be favorably designed as the manufacturing device and the manufacturing process for the mixed material from the initial materials can then be carried out by the mobile transport unit. In particular with the delivery of small quantities of mixed material the manufacturing device can be filled with the initial materials. Then the initial materials are transferred to the processing site by the manufacturing device itself and manufactured shortly before the actual delivery of the mixed material.

An especially favorable stage in the procedure is that at least a substantial part of the initial materials is manufactured in at least one manufacturing unit allocated to the control station. The initial materials required for a mixed material are normally produced by the manufacturers of the initial materials in an adequate and usually easily determinable quality. It is therefore obvious that the manufacturing process for at least most of the initial materials should be carried out in the immediate vicinity of the control station, so that in some circumstances quality inspections with regard to the initial materials can be handled by the control station. Consequently, the monitoring function of the control station is extended from the manufacturing process of the initial materials to, for example, the filling of the mobile transport unit through to the manufacture of the end product. With concrete the quality of the cement used in particular must be monitored as well as the quality and size of the aggregate materials. Also the quantities of initial materials required for a certain delivered quantity of mixed material are then precisely defined by the control station and the filling of the mobile transport unit monitored.

In particular with regard to the currently widespread popularity of mobile telephones, it is advantageous if the interchange of commands and/or monitoring signals from the control station to the mobile manufacturing device occurs via remote radio transmission. Appropriate coding or frequency ranges then ensure that no unauthorized access occurs. Also the relatively low associated costs are negligible in relationship to the manufacturing costs of the mixed material. Furthermore, continuous monitoring and control can be carried out from the start of the manufacturing process through to its conclusion.

Although it is also conceivable that only essential data is monitored or interrogated or only a start signal and possibly an end signal is received resp. transmitted from the control station, it is also provided according to one variant that the manufacturing process for the mixed material is mainly monitored and/or controlled completely by the control station. Whereas the access possibilities to a program controller provided on the mobile manufacturing device may be limited from the control station, with this variant of the method the control station has full control of the procedure and can carry out appropriate open-loop and closed-loop adjustments at any time. The control station therefore does not just have an exclusively monitoring function for controlling the quality standard, but instead process parameters can be adapted in the required manner during the manufacturing process. Consequently, an even higher level of security is achieved, because any influences on the manufacturing process at the processing site are completely eliminated and corrections can be immediately carried out from the control station.

Another variant of the method provides that predetermined process parameters of the manufacturing process for the mixed material are monitored using monitoring equipment and the manufacturing process is controlled via a comparison with the process parameters. This can also take place within the scope of a closed-loop control circuit. Since, for example with the manufacture of concrete, temperature and humidity effects play a decisive role, an adjustment or control can occur by continual checking of process parameters, both manually or also automatically. With fully automatic operation external influences are suppressed further.

Since with many mixed materials a chemical reaction takes place when dry initial materials are mixed with liquid initial materials, it proves to be particularly advantageous for the production of good quality if the mainly dry initial materials are fed into the mobile manufacturing device and/or stored in it separately from the mainly liquid materials. With concrete this means that water is not mixed with the cement before an appropriate signal is transmitted by the control station. Since water is an initial material, which in most countries is available at various places in approximately constant quality (supplied by the water supply utility), it is not essential that this initial material is fed into the mobile transport unit or the manufacturing device at the start. However a method must be available, which permits a controlled feed, in particular with regard to quantity, to the mobile manufacturing device. Here also the control station has control.

According to claim 9 the method is extended by at least one step in the processing of the mixed material. In this respect the mixed material provided by the mobile manufacturing device is passed to a processing facility and the processing procedure is carried out and monitored by means of an interchange of commands and/or monitoring signals between the control station and the processing facility. This monitoring of the processing procedure can also take place independently of any monitoring of the manufacturing process for the mixed material by the control station (possibly a partial registration), because, also according to this concept, remote monitoring takes place through a qualified station (control station). This means, for example, that the monitoring of the processing procedure gives the control station the possibility of making decisions about the reliable termination of the processing stages. This extension of the method therefore permits monitoring of the quality of the mixed material beyond the manufacturing process and this can be extended to the final application of the mixed material at the processing site. With concrete for example, this means that the monitoring is only terminated on pouring into the shuttering and the subsequent compaction at the construction site.

In this respect it is also advantageous if according to a further step in the process, the density of the mixed material processed by the processing facility at the processing site is monitored by the control station. In the case of concrete the compaction plays an important role, in particular in the prevention of air inclusions. Usually compaction is carried out using a vibratory compactor which is lowered separately into the concrete or, for example, is provided as an additional constituent part of a concrete pump. The monitoring of the vibration characteristics of this compactor could be sufficient for this type of purpose. Density measuring sensors, the values of which are transmitted to the control station, should however also be used. Acceptance by the control station only occurs after the concrete has been sufficiently compacted.

Furthermore, the invention relates to a quality monitoring system for carrying out the procedure according to one of the claims 1 to 10 with a mobile manufacturing device for the mixed material consisting of initial materials of a certain level of quality, a control station separate from the mobile manufacturing device for controlling and/or monitoring the manufacturing process for the mixed material by the mobile manufacturing device and transmission and receiving equipment, which is provided on the mobile manufacturing device and at the control station for the interchange of commands and/or monitoring signals for the manufacturing process.

The system is designed such that the manufacturing process for the mixed material is carried out in the immediate vicinity of the processing site, whereas the control of this manufacturing process and the monitoring of the quality, for example, is allocated to a single station (control station) which facilitates either automatic monitoring or monitoring by highly qualified specialist personnel, whereas the transport and the provision after the manufacture of the mixed material can be carried out by less qualified persons.

Furthermore, at least one mobile transport unit can be included for transferring at least a substantial part of the initial material to a processing site and/or temporary stores remote from the control station. These transport units may be simple, inexpensive transport vehicles, such as tipper trucks or similar, which transfer the initial materials to a processing site or to temporary stores substantially more economically.

In particular for small delivered quantities however, there may be provision that the mobile manufacturing device is designed as the transport unit for accepting a specified quantity of the initial materials of a certain quality level. In this respect the manufacturing device must have an appropriate capacity. The initial materials are normally passed unmixed in layers or similar to the transport unit.

It has been found to be particularly advantageous if the control station is a constituent part of a manufacturing plant for the manufacture of at least a substantial part of the initial materials. Consequently, the control station can also handle the control and monitoring functions with regard to the initial materials and the passing of the initial materials into the mobile transport unit and manufacturing device, so that a continuous quality chain for the manufacture of the initial materials is achieved up to delivery of the finished mixed material. Therefore, this variant is also especially favorable because the specified process parameters for the manufacture of the mixed material are in most cases specified by the manufacturing plant for the initial materials and a desirable quality can only be obtained with exact conformance.

Preferentially, the control station is provided with equipment for monitoring the quality level of at least a substantial part of the initial materials. If the control station is a constituent part of the manufacturing plant, monitoring occurs automatically. However, with a separated configuration, an additional quality inspection can be placed in an intervening location.

Furthermore, it can be provided that the manufacturing plant features filling equipment for filling the mobile transport unit with a specified quantity of initial materials and the control station includes equipment for monitoring the filling process of the mobile transport unit. For example, this is easily possible with the application of the silo technology used in the field of concrete manufacture. Also different mixtures of various initial materials can be automatically provided from this type of filling equipment, provided only initial materials are mixed together before the manufacturing process which do not react together without additional conditions.

Following on from this, it is also favorable if the mobile transport unit exhibits separate sections for the separate accommodation of mainly dry and mainly liquid initial materials. Often with mixed materials the liquid initial materials are the decisive factor in the initiation of a usually chemical reaction. Therefore it is advisable to keep these initial materials separate for as long as possible. Once the manufacturing process is started by the control station, mixing of the initial materials then takes place whereby the mixed material is produced with the desired properties.

The control station and/or the mobile manufacturing device may include a program control device for controlling and/or monitoring the manufacturing process for the mixed material. There is, for example, the possibility that when filling the mobile transport unit and/or manufacturing device a certain manufacturing program is loaded into the program control device in dependence of the initial materials. This manufacturing program is then activated at or in the vicinity of the processing site by the control station. Depending on the desired possible intervention it may also be advantageous if this programming takes place immediately in or directly from the control station. In this connection the object is to grant the control station as far as possible intervention in the process sequences, whereby unauthorized access should be eliminated as far as possible.

The mobile manufacturing device can include most favorably sensor devices for determining process parameters during the manufacturing process for the mixed material. A continual check on the manufacturing process with the tracing of any deviations and the check of whether this is correctly carried out is improved by this variant.

The transfer of the command and monitoring signals from and to the control station can also take place in interchange with a processing device. In this respect this device has transmitting and/or receiving equipment. Accordingly, the processing facility can also be monitored in the desired manner and the processing procedure set to a high quality level.

During the manufacture and processing of concrete or similar constructional materials, it is particularly advantageous if the mobile manufacturing device is a truck mixer, in particular a truck concrete mixer. The usual truck concrete mixers can only be employed under certain circumstances and in clearly defined processes, because this type of transport device has extremely poor mixing properties and is usually only purposefully employed as an agitator.

The inventor has already attended to the design of vibratory truck mixers which employ separate feeder methods for mainly liquid initial materials. Using a vibratory unit arranged inside the mixing drum complete mixing of the mainly solid and mainly liquid initial materials can be achieved with a relatively low energy expenditure. When fitted with appropriate additional technical systems, a vibratory mixer of this type can be used as a manufacturing device for the on-site production of concrete controllable from a control station.

Furthermore, it can be provided that the processing facility includes at least one vibratory compactor and some measurement instruments. These have been shown to be most useful in the compaction of concrete introduced into shuttering for the reduction of air inclusions using low energy expenditure. Variations in the vibration characteristics on account of the changing concrete density during the vibration process give information about adequate compaction. Appropriate monitoring measures can be provided.

To be also able to serve larger construction sites, according to a further variant, the processing facility may include a thick matter pump, in particular a truck concrete pump, arranged before the vibratory compactor. The truck concrete mixer fills the finished concrete directly into the truck concrete pump which pumps the concrete to the delivery point where it is then compacted by the vibratory compactors. Later developments from the inventor provide for the application of vibratory compactors at the end of the delivery pipe on the truck concrete pump, whereby immediate compaction of concrete can be carried out during delivery. The equipping as a modular unit also facilitates a better monitoring function.

The invention also relates to a mobile manufacturing device, in particular a truck concrete mixer, for use in a method according to one of the claims 1 to 10. This is designed as a manufacturing device. Furthermore, transmission and receiving equipment is provided for the interchange of commands and/or monitoring signals with a remote control station, whereby the transmission and receiving equipment interact with the manufacturing device for the direct, remotely controlled execution and monitoring of the manufacturing device. This means that previously known truck concrete mixers, for example truck vibratory mixers, can be equipped with appropriate transmission and receiving equipment which facilitates direct intervention in the manufacturing process by a remote control station.

Furthermore, it can be provided that the mobile manufacturing device is designed as a transport unit for at least a substantial part of the initial materials. The variant is particularly suitable for small quantities of the mixed material, because for example, a truck concrete mixer can be filled at the cement plant and travel to site in order to carry out the manufacturing process of the concrete on site.

In this connection it is also conceivable that logging of the complete transport and manufacturing process through to application can be carried out. This type of log can be output from the control station or after conclusion of the delivery or the application by the mobile transport unit or processing unit. The log then ensures that certain parameters have been maintained during the complete procedure, so that everything conceivably possible for achieving a desired quality has been carried out by the responsible persons.

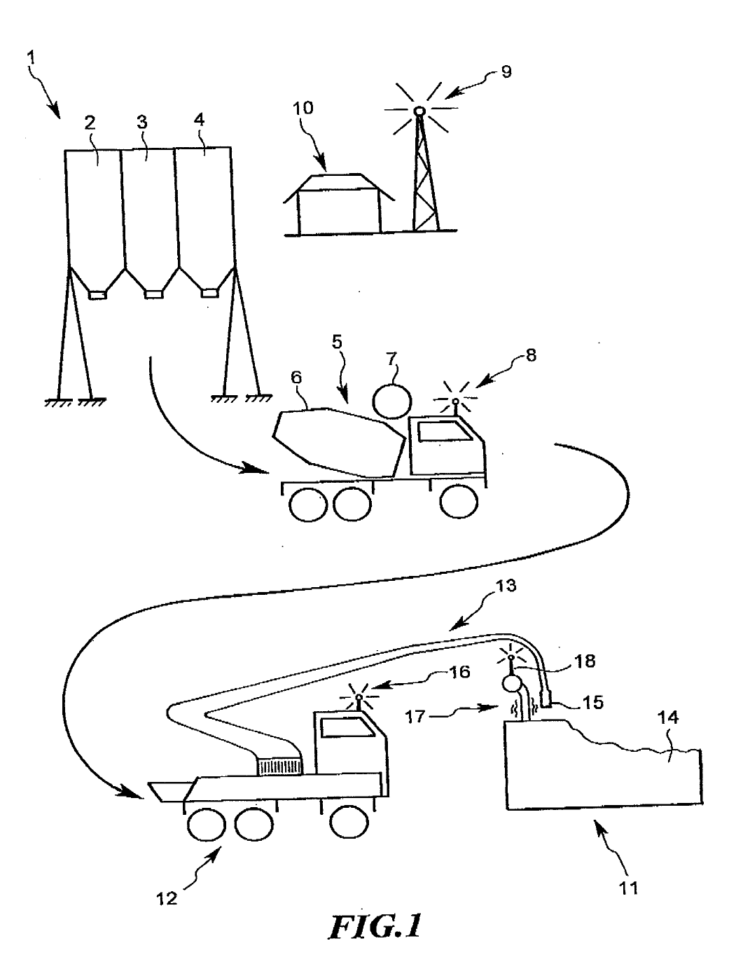

In the following this invention is explained in more detail based on the sole illustration, FIG. 1, and with reference to concrete manufacture.

In a cement plant 1 the most varied aggregate materials for cement are kept in the most varied silos 2, 3, 4. By accurate control of 2, 3, 4 by computer, cement can be supplied in the desired composition. By supplementation however, it is possible to also store the other initial materials for concrete manufacture in the cement plant 1 and to discharge them in dosed quantities. This discharge generally takes place to a truck concrete mixer 5. In the main mixing drum 6 all solid initial materials are filled in a random sequence for the concrete manufacture. A certain quantity of water is stored in the tanks 7 above the main mixing drum. The truck concrete mixer, in this case a vibratory mixer, possesses a transmitting and receiving system 8, which is in contact with the transmission and receiving system 9 of a control station 10. In the most simple case the transmission and receiving systems 8, 9 and the transmission method may take place by mobile telephone which permits adequate transfer of the desired data.

The truck mixer 5 travels from the cement plant 1 to the processing site 11 with the initial materials. Once it has arrived at the processing site 11, the status is transmitted by the transmission and receiving system 8 to the control station 10. Also equipping with GPS systems can be provided for the automatic detection of whether the truck mixer 5 has already reached its destination.

The control station 10 now issues the signal using the transmission and receiving system 9 for carrying out the manufacturing or mixing process for the manufacture of the concrete. In this respect the main mixing drum 6 is put into operation and a certain quantity of water introduced from the tank 7. This complete manufacturing process takes place with monitoring from the control station 10 under continuous interchange of signals via the transmission and receiving systems 8 and 9. Depending on the level of the desired control, the monitoring functions and the intervention possibilities from the control station 10 can be arranged to various degrees. The monitoring range extends from the issuing of the start signal from the control station 10 with the ensuing program control sequences of the manufacturing process using a program controller on the truck concrete mixer 5 through to the full monitoring and closed-loop control of the complete manufacturing process from the control station 10.

Once the manufacturing process has been carried out with the specified parameters, the control station 10 issues permission for applying the concrete. The concrete is transferred to the truck concrete pump 12 from the truck mixer 5 and is transferred to the construction site 14 using the tubular mast 13. The concrete then flows into the shuttering at the end 15 of the pipe work.

The truck concrete pump 12 is also equipped with a transmission and receiving system 16, so that monitoring and/or control of the pump process also occurs from the control station 10. Appropriate control and monitoring signals are interchanged.

The compaction of the concrete at the construction site 14 takes place using vibratory devices which also possess a separate transmission and receiving system 18. Consequently, control and monitoring of the vibratory devices 17 are also possible from the control station 10. The control station 10 is also responsible for the adequate compaction of the concrete at the construction site 14. The vibratory device 17 can also be coupled to the truck concrete pump 12, so that a processing unit is created which also possesses common monitoring and remote control equipment.

The integration of the truck concrete pump 12 and the vibratory devices 17 in the monitoring process facilitates the control, monitoring and final inspection of the complete processing of the concrete including pouring at the construction site 14 from a single responsible station (control station 10). As a result, a high quality is possible at the processing site even using less qualified workers, because the overall control is handled by appropriate equipment and/or qualified specialist personnel suitable for this equipment. This continuous control of the complete production process, which is terminated with the placing of the constructional material in the structure, will produce moderate progress in concrete technology, because errors can be eliminated at an early point in time. Whereas currently a strict monitoring of the process parameters and the density of the applied concrete is carried out by this invention, in future with the development of appropriate inspection methods it will be conceivable that this will also be immediately carried out afterwards using remotely controlled monitoring from the control station to provide an immediate check and final quality inspection of the applied constructional material.

1. Quality monitoring procedure for carrying out and monitoring the manufacturing process of a mixed material which can be created from a number of initial materials, in particular ready-mixed concrete and similar constructional materials, with the following steps:
provision of at least a substantial part of the initial materials in a certain quality level;
transfer of at least a substantial part of the initial materials to a remote processing site;
execution of a program controlled manufacturing process for the mixed material from the initial materials using a mobile manufacturing device which can be set up at the processing site;
interchange of remotely transmitted command and/or monitoring signals between a control station remotely situated from the mobile manufacturing device and the mobile manufacturing device for at least starting the program controlled manufacturing process for the mixed material from the initial materials.

2. Method according to claim 1, characterized in that the transfer of at least a substantial part of the initial materials takes place using at least one mobile transport device (5).

3. Method according to claim 2, characterized in that the mobile transport unit (5) is designed as a manufacturing device and the manufacturing process for the mixed material from the initial materials is carried out by the mobile transport unit (5).

4. Method according to one of the claims 1 to 3, characterized in that at least a substantial part of the initial materials is manufactured in at least one manufacturing unit (1) allocated to the control station (10).

5. Method according to one of the claims 1 to 4, characterized in that the interchange of command and/or monitoring signals takes place using remote radio transmission.

6. Method according to one of the previous claims, characterized in that the manufacturing process for the mixed material is substantially completely monitored and/or controlled by the control station (10).

7. Method according to one of the previous claims, characterized in that specified process parameters for the manufacturing process for the mixed material are monitored using monitoring equipment and the manufacturing process is controlled by comparison of process parameters.

8. Method according to one of the previous claims, characterized in that substantially dry initial materials are passed to the manufacturing device (5) and/or stored in it separately from substantially liquid initial materials.

9. Method according to one of the previous claims, which is extended by at least one processing step for the mixed material, characterized in that the mixed material delivered by the mobile manufacturing device (5) is passed to a processing facility (12, 17) and the processing facility is controlled and monitored by the interchange of command and/or monitoring signals between the control station (5) and the processing facility (12, 17).

10. Method according to claim 9, characterized in that the density of the mixed material processed by the processing facility (12, 17) at the processing site (11) is monitored by the control station (10).

11. Quality monitoring system for carrying out the method according to one of the claims 1 to 10, comprising
a mobile manufacturing device for manufacturing the mixed material from initial materials of a certain quality level,
a control station (10) separate from the mobile manufacturing device for controlling and/or monitoring the manufacturing process for the mixed material carried out by the mobile manufacturing device,
transmission and receiving equipment, which is provided on the mobile manufacturing device and at the control station (10) for the interchange of command and/or monitoring signals for the manufacturing process.

12. System according to claim 11, characterized in that at least one mobile transport unit (5) is included for transferring at least a substantial part of the initial materials to a processing site (11) and/or temporary stores situated remote from the control station (10).

13. System according to claim 12, characterized in that the mobile manufacturing device is designed as a transport unit (5) for accepting the specified quantity of initial materials of a certain quality level.

14. System according to one of the claims 11 to 13, characterized in that the control station (10) is a constituent part of a manufacturing plant (1) for the manufacture of at least a substantial part of the initial materials.

15. System according to one of the claims 11 to 14, characterized in that the control station (10) is provided with equipment for monitoring the quality level of at least a substantial part of the initial materials.

16. System according to one of the claims 11 to 15, characterized in that the manufacturing plant (1) features filling equipment for filling the mobile transport unit (5) with a specified quantity of the initial materials and the control station (10) includes equipment for monitoring the filling process of the mobile transport unit (5).

17. System according to one of the claims 11 to 16, characterized in that the mobile transport unit (5) features separate accommodation sections for separately accommodating substantially dry and substantially liquid initial materials.

18. System according to one of the claims 11 to 17, characterized in that the control station (10) and/or the mobile manufacturing device includes, respectively include program control equipment for controlling and/or monitoring the manufacturing process for the mixed material.

19. System according to one of the claims 11 to 18, characterized in that the mobile manufacturing device includes sensor devices for determining the process parameters during the manufacturing process for the mixed material.

20. System according to one of the claims 11 to 19, characterized in that a processing facility (12, 17) is provided which includes transmission and receiving equipment (16, 18) for the interchange of command and/or monitoring signals with the control station (10).

21. System according to one of the claims 11 to 20, characterized in that the mobile manufacturing device is a truck mixer, in particular a truck concrete mixer.

22. System according to claim 21, characterized in that the truck mixer (5) is a truck vibratory mixer with separate feed arrangement for substantially liquid initial materials.

23. System according to one of the claims 11 to 22, characterized in that the processing facility includes at least one vibratory compactor (17).

24. System according to claim 23, characterized in that the processing facility includes a thick matter pump (12), in particular a truck concrete pump, situated before the vibratory compactor (17).

25. Mobile manufacturing device, in particular truck concrete mixer, for application in a method according to one of the claims 1 to 10, characterized in that it includes transmission and receiving equipment (8) for the interchange of command and/or monitoring signals with a remote control station (10), and the transmission and receiving equipment has an interactive relationship with the manufacturing device for the direct, remotely controlled execution and monitoring of the manufacturing device from the control station (10).

26. Mobile manufacturing device according to claim 25, characterized in that it is equipped as a transport unit (5) for at least a substantial part of the initial materials.
